(19) United States
(12) Patent Application Publication
(10) Pub. No.: US 2025/0128219 A1
(43) Pub. Date: Apr. 24, 2025

(54) A MIXING SYSTEM INCLUDING FILLABLE 3D FLEXIBLE POUCH FOR BIOPHARMACEUTICAL FLUIDS, AND METHOD FOR IMPROVING MIXING IN SINGLE-USE BIOREACTOR

(71) Applicant: SARTORIUS STEDIM FMT SAS, Aubagne (FR)

(72) Inventors: Jim SUMMERTON, Park Ridge, NJ (US); Dennis LAVERE, Patchogue, NY (US)

(73) Assignee: SARTORIUS STEDIM FMT SAS, Aubagne (FR)

(21) Appl. No.: 18/572,019

(22) PCT Filed: Jun. 17, 2022
(86) PCT No.: PCT/EP2022/066637

§ 371 Date: Dec. 19, 2023

(30) Foreign Application Priority Data
Jun. 24, 2021 (EP) 21181542.8

(51) Int. Cl. B01F 35/513; B01F 23/53; B01F 27/808; B01F 101/22

(52) U.S. Cl. CPC B01F 35/513; B01F 23/53; B01F 27/808; B01F 2101/22; B01F 2215/0409

(57) ABSTRACT

Initially heterogenous biopharmaceutical composition is mixed in a bag designed as a mixed bioreactor with capacity of at least 1500 liters, using an apparatus that includes a tank, the flexible and collapsible bag received in the tank and a stirring device. The device includes an impeller driven from below for initiating agitation adjacent to a tank base. Once the bag is stretched under liquid pressure, it becomes parallelepiped with a bottom wall, a top wall and a sidewall. The bag, in contact against four side panels of the tank, has a rectangular cross section including four rounded corners each spaced from the side wall.

### FIELD OF THE INVENTION

The present invention relates to container systems for mixing and storing fluid compositions used in biopharmaceutical field. It also relates to a method for mixing a biopharmaceutical composition in single-use bioreactor, in which a stirrer is driven from below.

By “biopharmaceutical composition”, it is meant a product coming from biotechnology, culture environments, cell cultures, buffer solutions, artificial nutrition liquids, blood products and derivatives of blood products, or a pharmaceutical product, or more generally, a product intended to be used in the medical field. Such a product/composition is in liquid or paste form after mixing. The invention also applies to the filling of flexible pouches with other products but subjected to similar requirements concerning the packaging thereof.

### BACKGROUND OF THE INVENTION

The mixing and/or suspension of solutions is ubiquitous in many technologies. For example, biotech companies use extensive amounts of culture media, buffers, and reagents. Such materials originally come in powdered form and must be hydrated with purified water prior to use. The hydration process typically comprises combining a precise amount of powdered material and purified water in a closed reservoir. As disclosed for instance in document U.S. Pat. No. 7,153,021 B2, the reservoir is typically a bag of flexible plastic material, which is a disposable/single-use 3D fillable bag. The bag, which may have a polygonal section, is disposed inside a rigid container of cylindrical shape. A special mixer is then used to mix the components into the desired solution. A stir member is provided inside the bag and is driven from below. As disclosed in document US 2011/0158037, bags can be removably placed in a rigid container having same transverse rectangular section as the side wall of the bag, allowing a centering of the stir member. In use, such bag of parallelepiped shape is provided with a spraying and dispersing device at a bag upper wall of rectangular section.

Use of collapsible bags having side panels is of interest for storing the bag before use, in a folded state. When draining, the bag easily collapses. Commercially available bags Flexsafe® Pro Mixer, from Sartorius Stedim, are designed to fit inside a rigid container and are suitable to contain various amounts of products to be mixed since the stirring device is located on the bottom wall of the bag.

In 3-D bags of this type, single-use and configured to receive a biopharmaceutical product, the volume is typically delimited by a lower end wall, an upper end wall and a flexible lateral wall, which could be located in two extreme states—folded-flat and expanded-unfolded. The 3-D bag can be deformed to pass from either of these states or be in a whole intermediate state. The walls of the bag, composed of a single-layer or multilayer film, made of plastic material such as polyethylene or a complex comprising polyethylene, delimit an inner space which, in folded state, is of minimum volume and, in unfolded and expanded state, is maximum. Such a flexible bag, biocompatible, single use, can be of significant volume (1000 L for instance). Such a bag thus offers a significant capacity, while being able to be easily stored. The U.S. Pat. No. 10,232,331 B2 discloses a rigid container receiving such bag, the rigid container being provided with a movable drive unit to drive the stirring device from below.

In large-scale operations, the use of flexible bags supported by an outer stainless-steel support vessel allows single-use operation. A rectangular section of the support vessel may be preferred for controlling the folding and unfolding operations. However, at such large scales, mixing efficiency becomes an issue and accordingly there is a need for large scale single-use systems with improved mixing. Document U.S. Pat. No. 10,857,510 B2 discloses a bioprocess mixer, provided with two magnetic impellers driven from below, making the system relatively complex. Such bioprocess mixer, with aim at overcoming issues for rapid mixing large volumes, requires a driving solution that is relatively complex.

There is thus still room for improving mixing, using bags that are convenient, for instance using a kind of collapsible bag easy to transport in an initially folded state, with a stirring device included in the interior volume of the disposable bag.

### SUMMARY OF THE INVENTION

Embodiments of the invention provide an apparatus capable of mixing a biopharmaceutical composition including a liquid, comprising:
a bag, made of flexible plastic material, provided with a bottom wall, a top wall and a tubular sidewall (the tubular wall typically extending from the bottom wall to the top wall so that the bag delimits an interior volume);
a tank provided with a base that is rectangular, the tank comprising a side wall that is rigid and provided with four panels extending upwardly from the base, in order to delimit a receiving compartment;
a stirring device located in the interior volume and adapted to be driven from below, at the opposite from the top wall;
   wherein the bag is arranged above the base and between the four panels, in the receiving compartment,
   wherein the bag, in an unfolded configuration of the bag with the liquid present inside the bag, has a parallelepiped configuration,
   wherein the bag, once placed inside the tank and unfolded according to the unfolded configuration, is:
extending generally vertically, parallel to a central axis of the tank that intersects an upper opening of the tank,
provided with a generally rectangular cross section including four rounded corners that are each spaced from the side wall of the tank, the rectangular cross-section being in correspondence with rectangular distribution of the four panels, and
satisfying the two following relationships:

$$0.1 < 4 r / p < 0.45 \\ V 2 \geq 1500 L$$

where p is an inner perimeter at the base to delimit the receiving compartment, r is a curvature radius as measured at any one of the four rounded corners, and V2 is the capacity of the bag.

Thanks to this arrangement, the stirring device 3 may act more efficiently to create a vortex at upper level of the liquid present in the interior volume, despite significant height which may be superior to 900 mm, preferably superior to 1600 mm. The significant rounding at the bag corners RC1, RC2, RC3, RC4 is formed because the bag 2 no longer touches the walls of the tank in the corners and because of enough reduction of the contact area with the tank panels. The radius of curvature can be more than 160 mm when the bag perimeter p delimits at/along the base is in the range [3000−4200] mm. It is understood that the ratio r/p can be greater than 0.05 and lower than 0.10, in some options. When the perimeter p corresponding to tank inner section is about 4000 mm, the radius of curvature r may thus be much larger than 100 mm and possibly lower than 400 mm.

The bag 2 may withstand liquid pressures by having a multilayer film thickness broadly greater than 100 or 200 micrometers, for instance greater than 380 micrometers but less than 700 micrometers. The film material of the bag 2 thus can remain flexible (easy to fold/unfold), facilitating folding when filling the bag 2 and collapsing effect when draining the product. The wide central face portions of the bag may stretch under the liquid pressure to meet the walls of the tank while the corners stretch much less, creating more of a radius in each corner.

The mixing occurs for large volumes, including the case of a capacity greater than 2000 L, without waiting too much time (typically about two minutes or less) after starting the rotation of a lower impeller or any suitable stirring part of the stirring device.

In some options, a lifting and deployment of the mixing bag are performed before any mixing, in order to ensure the top wall of the bag is initially at least 1500 or 2000 mm higher than the bottom wall. This is of interest to prevent undesirable folds in the bag sidewall.

In practice, it is desirable that the flexible bag can be expanded without undesirable folding which limits the actual folding volume. Instead of requiring a human monitoring, because of the expansion defects, a lift system may be fasted to the tank, in order to lift a top end of the bag before any unfolding of the sidewall due to liquid pressure.

Optionally, the bag is a gusseted bag with two opposite gussets.

The two gussets may interconnect two outer sheets of greater surface than the gussets. The gussets are each delimited between a pair of longitudinal seams, so that the bag includes four longitudinal seams, a portion thereof can extend vertically in parallelepiped configuration of the bag, forming corner seams as view in any cross-section.

Typically, with such arrangement, the longitudinal seams, forming corner seams as view in any cross section, can be maintained each at a distance from the rigid walls of the outer tank. The seams may of high strength as compared to plastic material strength for the bag. In such case, the pouch withstands the weight of the content and keep a generally rectangular section due to the very strong seams. Preferably, an overlapping width at the welded regions forming the longitudinal seams is superior or equal to 6 or 7 mm, for instance between, 7 or 8 mm and 15 or 20 mm.

The central faces of the bag stretch under the flowable content pressure (water pressure for instance) to meet the walls of the outer tank while the corners stretch much less, creating more of a radius in each corner.

Using such kind of bag able to stretch for contacting the inner face of the tank selectively in areas away from the tank edges, with a significant rounding in the corners of the cross-section of the bag, facilitates creating proper vortex to quickly (typically less than two minutes) mix the liquids or the liquid and the solid (for instance powder material).

Option with seams of high strength, vertical and stronger that the bag wall may be of interest for having low or no variation of the bag cross-section in the part of the bag filled with liquid.

In some embodiments, the bag is in contact with each of the four panels that are vertical panels. Contact between the bag and each of the four vertical panels may obtained at four respective rectangular contact areas which extend each upwardly from the base. Typically, the rectangular contact area along a given panel is obtained with a contact width representing more than 50%, preferably, at least 60%, of the panel width of the given panel.

In various embodiments of the present invention, one or more of the following arrangements may possibly be employed, separately or in combination:
the bag is a flexible pouch specially designed to contain a biopharmaceutical fluid, preferably without any metal in layer(s) of the film material of the bag.
the bag is provided with at least one port, which is arranged at the top wall or at the bottom wall.
the two gussets are stretched to be in contact with two opposite panels of the tank.
in unfolded parallelepiped configuration, the two gussets include each a first gusset portion that belongs to a given panel part of the bag sidewall and two second gusset portions that belong to two other wall portions of the bag which are adjacent to the given panel part.
according to an option, in unfolded parallelepiped configuration, a pair of portions amongst the second gusset portions distributed in the two gussets are triangular or trapezoidal portions facing the base of the tank, preferably in contact with the base of the tank.
according to another option, in unfolded parallelepiped configuration, the two second gusset portions belong to the bag sidewall, while the two gussets further include each a third gusset portion, which is an elongated gusset margin that is in contact with the base of the tank.
the two gussets have each a lower margin portion that extends, in unfolded configuration, along the base.
the tank is provided with a lower space available for a drive unit, for driving the stirring device.
the impeller extends at mid distance between the gussets, in parallelepiped configuration.
the stirring device comprises only a single impeller, which is preferably a Rushton impeller, driven via a shaft or magnetically driven.
a spacing height between the impeller and the top wall is comprised between 2000 and 3400 mm.
the bag has a height measured between the bottom wall and the top wall in the unfolded configuration, the height being superior to 900 mm, preferably superior to 1600 mm.
the height of the unfolded bag may be inferior or equal to 4000 mm, preferably comprised between 2000 and 3400 mm.
the bag has a longitudinal extension and comprises four plastic sheets and four longitudinal seams so that two of the four plastic sheets are gussets.
each of the four longitudinal seams includes two longitudinal sheet margins distributed in two adjacent plastic sheets that are part of the bag.
the two gussets are identical sheets, preferably made of a multilayer plastic film.
the bag is only made of four sheets of same/identical plastic material.
the bag has a height measured between the bottom wall and the top wall in the unfolded configuration, the bag comprising two end seals that are distant from an initial distance, in folded state of the bag, which is higher than the height,
the two end seals, which extend parallel, are each connected at a first junction with two of the four longitudinal seams and at a second junction with two others of the four longitudinal seams.
each of the two gussets defines a bag panel, in unfolded state, which is generally perpendicular to the two end seals.
the inner perimeter at said base is identical to an inner circumference delimited by the four panels.
the bag in the unfolded configuration is kept upright without any contact between the four longitudinal seams and the four panels (side panels).
the tubular sidewall has a given height in the parallelepiped configuration, with each of the seams having an elongated seam portion that is extending vertically and protruding outwardly from the tubular sidewall of the bag.
the four longitudinal seams (elongated welds) may have a width typically higher than 5 mm and may optionally act as braces and reinforce the square or rectangular base/cross-section (the contact areas with the tank panels can be each wide): this can be considered of interest for the filling of the bag, by allowing a rounding without having the radial gap too great between the bag and the corner areas of the tank.
contact between the bag and each of the four vertical panels is obtained at four respective rectangular contact areas which extend each upwardly from the base.
the apparatus comprises a bracket and a linking element coupled to the bracket for unfolding the bag, by a lifting displacement of a top end of the bag (the bracket belonging to a lift system), and holding the top end of the bag.
the linking element is configured to be engaged with the bag at or through a stiffening part at the top end.
the bag may be provided with a stiffening part at the top end with a through hole arranged in and/or surrounded by the stiffening part.
the linking element is configured to pass through/be inserted the through hole in a hold configuration of the bag using the bracket and the linking element.
a fastening element is provided to selectively retain a central region of the bottom wall 2a, in a predetermined position relative to the tank base (forming a bottom of the receiving compartment), wherein the sidewall is unfolded in response to a lift action exerted at a top end of the bag, by a lift system.
the lift system extends above and/or rests on a annular frame of the tank which surrounds an upper opening of the tank.
the annular frame protrudes radially outwards relative to a tank outer face of rectangular section.
the tank is provided with spacers covering the vertical edges, the spacers preferably being made of a material as rigid or less rigid than the tank. Preferably, the spacers are not deformed under pressure exerted by the vertical corner regions of the bag, in filled state of the bag.
the spacers are inflatable or expandable, such spacers being possibly controlled to be deployed or expanded only after the filling of the bag has started.

In some embodiments, the bag has opposite end seals. Either the two end seals are distributed in the bottom wall and the top wall, with the stirring device comprising an impeller that is shifted laterally relative to the end seal provided in the bottom wall, or the two end seals are provided in the tubular side wall, with the stirring device comprising an impeller that is preferably arranged centrally with respect to the bottom wall.

Optionally, the bag comprises:
a first opening in the bottom wall, the stirring device having a shaft, a guiding protrusion or any suitable equivalent insert extending along a vertical virtual axis and through the first opening; and
a second opening in the top wall, suitable for introduction of powder in the interior volume from above.
   Two respective ports may be provided at such openings.
   The first opening is provided in one of the four sheets. A receiving cup, rigid or of a material more rigid than plastic of the four sheets, may tightly cover the first opening. The stirring device can be partly inserted in a recess delimited by the receiving cup and driven magnetically from below the base.

It is also provided a method for mixing in single-use bioreactors, using a bag specifically designed to contain a biopharmaceutical composition including a liquid, wherein the bag, made of flexible plastic material, is a 3D-bag adapted to have a parallelepiped configuration so that the bag is provided with a bottom wall, a top wall and a tubular sidewall extending from the bottom wall to the top wall, the method comprising unfolding the bag due to liquid pressure of a liquid, without any contact of corners formed at any cross-section thereof below liquid upper level with sides panels of a tank, in which the bag is received, wherein liquid content of the bag is mixed by a stirring device extending in the bag and optionally driven from below a base of the tank.

The method may comprise the steps essentially consisting in:
opening a front opening that opens to a receiving compartment of a tank, the tank comprising a side wall that is rigid and provided with four panels extending upwardly from a base that is rectangular, in order to delimit the receiving compartment;
placing the bag in the receiving compartment, above the base;
while the front opening is open, connecting a stirring device, which extends inside the bag, to a drive unit arranged below the receiving compartment, the stirring device being configured to be driven from below, at the opposite from the top wall;
lifting a top end of the bag to start unfolding two opposite gussets of the bag;
filling the bag with liquid, the filling being possibly performed simultaneously with further unfolding of the bag to reach parallelepiped configuration of the bag;
   wherein the bag, once placed inside the tank and unfolded according to the unfolded configuration, is:
extending vertically, parallel to a central axis of the tank that intersects an upper opening of the tank,
provided with a rectangular cross section including four rounded corners that are each spaced from the side wall of the tank, the rectangular cross-section being in correspondence with rectangular distribution of the four panels, and
satisfying the two following relationships:

$$0.1 < 4 r / p < 0.45 \\ V 2 \geq 1500 L$$

where p is an inner perimeter at said base to delimit the interior volume, r is a curvature radius as measured at any one of the four rounded corners, and V2 is the capacity of the bag.

### BRIEF DESCRIPTION OF THE DRAWINGS

We will now describe several embodiments of the invention with the aid of the drawings, in which:

FIG. 1 is a perspective view showing a stirring operation, performed in an apparatus of the type mixer-container according to one possible embodiment, with a vortex obtained at the top surface of the liquid contained in the flexible bag of the apparatus, the top wall of the bag being omitted;

FIG. 2 illustrates an apparatus in accordance with an embodiment, when pouring powder from a powder transfer bag into the filled bag housed in the rigid outer tank, the removable drive unit being represented in dash lines;

FIG. 3 shows a 3-D flexible bag before a filling with a biopharmaceutical fluid, according to a first embodiment;

FIGS. 4A and 4B3 shows a 3-D flexible bag before a filling with a biopharmaceutical fluid, according to a first embodiment;

FIG. 5A is a perspective view of a 3-D flexible bag according to an option adapted for placing the impeller at a lower face delimited by two parallel welds and with two end seals arranged on two opposite faces of the bag side wall;

FIG. 5B is a perspective view of a 3-D flexible bag according to another option adapted for placing the impeller above a lower face delimited by two parallel welds and with the two end seal distributed on the lower face and the upper face of the bag, respectively;

FIG. 6 schematically illustrates, in a cross-section view, an exemplary way of assembling four films/sheets for constituting the 3-D flexible bag, the sheets being assembled and welded at four longitudinal seams;

FIG. 7 illustrates situation with white powder not easily mixed with liquid contained in a bag of large height, due to absence of vortex, the bag being fitted in a tank of rectangular section;

FIG. 8 is a photograph reflecting a top view of the content of another bag, in situation with efficient powder-liquid mixing, due to presence of a vortex;

FIG. 9 schematically illustrates a cross-section of the apparatus in accordance with an embodiment, with significant corner gaps obtained due to a sufficient curvature radius;

FIG. 10 is a top view showing the inside of the apparatus, above the liquid level, according to an embodiment involving spacers.

### DETAILED DESCRIPTION

Below, a detailed description of several embodiments of the invention matched with examples and in reference to the drawings.

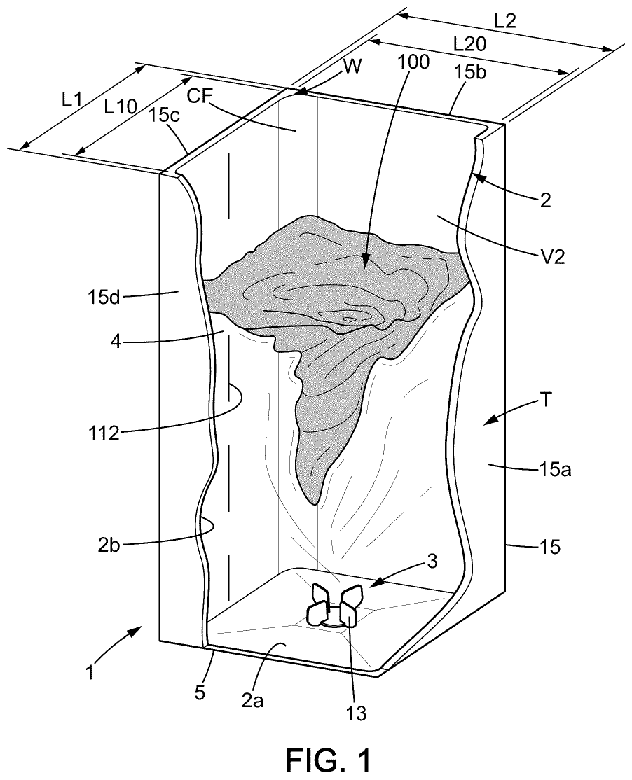

In the different figures, identical references indicate identical or similar elements. As illustrated in FIGS. 1, 3 and 5A-5B, the apparatus 1 is provided with a flexible bag 2 which is expanded in three dimensions in a filled state. The bag 2 has initially a flat configuration, wherein two opposite wall elements 21, 22 define two main opposite outer faces of the flexible bag 1. It can be seen this flexible bag 2 has openings and/or connection ports for filling and/or emptying. The apparatus 1 comprises a stirring device 3, the agitation/stirring part thereof extending in an interior volume V of the bag 2. The apparatus 1 can act as a mixer-container, adapted to receive a biopharmaceutical fluid for mixing, or where appropriate for a chemical and/or biological reaction (or bioreaction), the mixer-container then being a bioreactor.

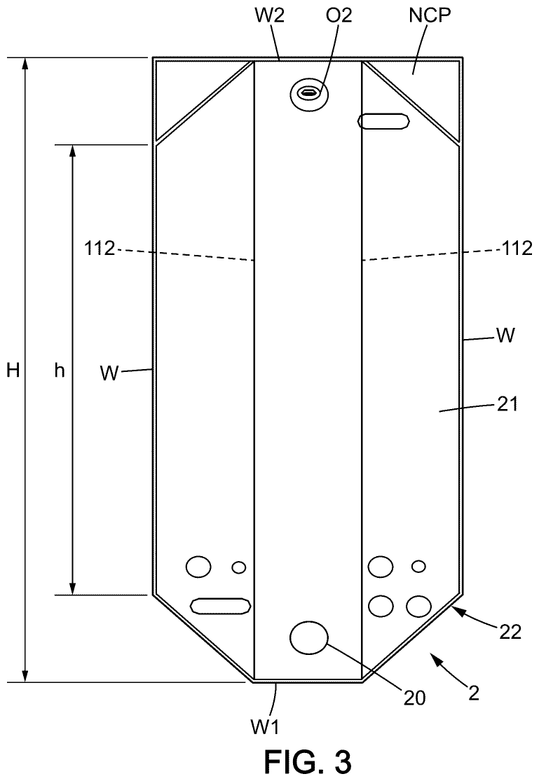

Referring to FIGS. 3 and 6, the bag 2 may be configured to form a flexible pouch with a generally parallelepiped shape once filled with liquid. The bag 2 of flexible plastic material comprises a bottom wall 2a, a top wall 2b and a tubular sidewall 2c extending from the bottom wall 2a to the top wall 2b so that the bag 2 delimits the interior volume V. Here the volume V is at least 1500 liters with a significant height H, which may be the greatest size of the 3D-bag The term “parallelepiped” means that the tubular sidewall 2c has a cross-section with four edges (two pair of parallel edges) that define a square or a rectangle. The bag 2 can easily unfold before a filling with liquid and cab easily collapse after draining the flowable biopharmaceutical product 4, which is a mixing of the liquid with at least one additional substance.

The stirring device 3 is configured to allow a mixing of a biopharmaceutical composition/product 4 contained in the interior volume V, possibly to quickly disperse powder material or another suitable additional substance. The stirring device 3 may be arranged to have an impeller 13, typically a single impeller located inside the bag 2 and driven from below the bag 2, in the filled state. In other words, the rotor of the stirring device extends inside the bag 2, for instance with the impeller 13 located as close as possible from the bottom wall 2a. The height level of the impeller can be fixed.

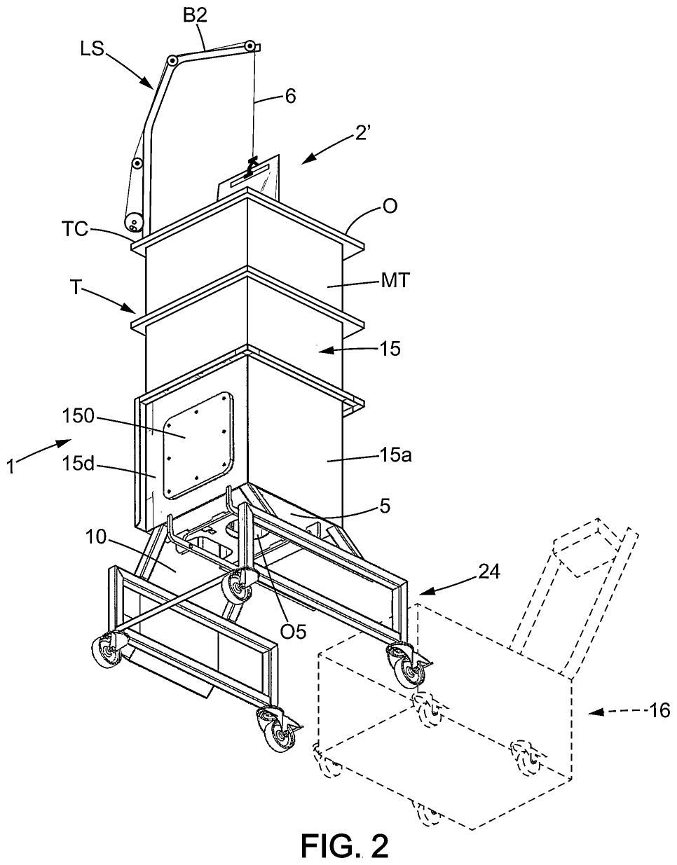

As shown in FIGS. 1 and 2, the bag 2 is adapted to be received inside a rigid container forming a tank T with a significant height, for instance superior to 1000 or 2000 mm. The tank T is maintaining the tubular sidewall 2c vertically, so that this sidewall 2c extends longitudinal around a central axis X (vertical axis, here) of the tank T. The tank T may be designed as a rigid hollow tower, with height of the tank T greater than 2000 mm, for instance about 3000 mm in a non-limiting option.

The tank T may include one or more modules MT of substantially same cross-section, here superimposed, to define a side wall 15 that is rigid. The tank T typically includes a front opening 150 allowing the bag 2, still folded, to be introduced inside the tank T, above the base 5. The front opening 150 is here vertically distant (far below) the upper edge of the tank T. As shown in non-limiting embodiment of FIG. 2, the tank T may be designed to receive a drive unit 16 in a lower space 10 provided below the receiving compartment of the tank T.

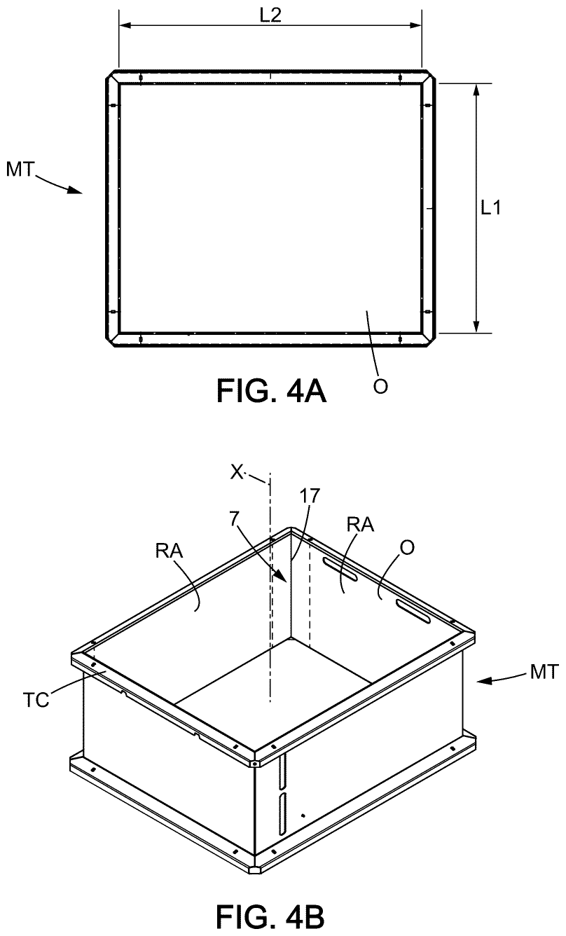

FIGS. 4A-4B show an exemplary module MT that delimits a cross-section which is of rectangular shape, with 90° angles. The width L1 and the length L2 may be each superior to 700 or 800 mm. One or more slots may be provided near the top of such module MT, allowing quick and removable fixture of a cover or of some inserting elements. In some embodiments, one or more elongated spacers 35 may be placed vertically along a vertically elongated corner area 7, in order to cover the corresponding vertical edge of the tank module MT. A non-limiting example of such spacers 35 is illustrated in FIG. 10. The spacers 35 may have two outers guiding faces arranged perpendicular or any suitable section for fitting with a guiding effect along the corresponding tank edge 17. Here, each spacer 35 is overlapping two vertically extending margin portions of the two adjacent tank panels that join at the edge 17. Two, three of four spacers 35 may be arranged along the respective edges 17, in order to help in positioning the bag section properly, with the rounded corners RC1, RC2, RC3, RC4 resting on such spacers 35 without any contact with the rigid side panels 15a, 15b, 15c, 15d.

The tank T may be designed, either as a single block, or provided with a main part provided with a base opening O5, in the base 5 of the tank T, and one or more modules MT vertically added on the main part. The base opening O5 is forming an access for driving in rotation the impeller 13. The panels of the tank may be distributed in several parts, in particular when using one or more addition tank modules MT. A drive-bag interface may be formed, using a connector of tubular shape or similar suitable connecting part, entering inside the tank via the base opening O5. Such base opening O5 opens vertically upwards in a receiving compartment delimited by the panels 15a, 15b, 15c, 15d of the tank T.

More generally, a drive-bag interface is present and a coupling with the stirring part is obtained, typically before any filling of the bag 2 resting on the base 5. In some embodiments, a coupling clamp (for a mechanical coupling or a magnetic clamp) is inserted with its aligner, before any bag unfolding for instance. A movable motorized device of a known type, possibly a magnetic mixer drive unit 16, may be placed just below the tank T (in the lower space 10), with a tubular coupling part or similar connector engaging the drive-bag interface that typically protrudes downwardly from the base 5 though the base opening O5. The lower structure 24, extending entirely below the receiving compartment, may be a part of/integral with the tank T, possibly with wheels for transport.

Referring to FIG. 2 with the bag 2 entirely received inside the tank T, below the upper opening O, the tank T has a parallelepiped shape, forming a receiving compartment. The base 5 is here rectangular (possibly squared) and the upper opening O is also delimited by a frame forming a rectangular circumference. The cross-section of the tank T may be the same all along the height of the receiving compartment. In preferred embodiments, the side wall 15 is provided with four panels 15a, 15b, 15c, 15d extending upwardly from the base 5, in order to delimit a receiving compartment. The unfolding of the bag 2 may be facilitated by using a lift system LS, for instance before the filling. Besides, a clamping interface can be used for holding a cap element, a neck or similar part of the top wall 2b, once the bag 2 is in its unfolded configuration.

The apparatus 1 here comprises a bracket B2, which is typically rigid, and a linking element 6 coupled to the bracket B2. The linking element 6 may be flexible and can be drawn to lift the bag 2. The lift system LS is suitable for:
helping in the unfolding of the bag 2 by a lifting displacement of a top end of the bag 2;
and holding the top end of the bag 2, during progressive unfolding of the bag 2.

Besides, the apparatus 1 may include a plate or similar rigid cover (not shown) that supports a powder transfer bag 2′. Such cover includes a passageway for the powder pouring operation which may be disposed above the bag. The powder transfer bag 2′ may contain at least 10 L of powder material, for instance at least 30 L. This powder transfer bag 2′ may be lifted, optionally using same lift system LS as illustrated in FIG. 2.

Powder addition can take place only when the bag 2 is positioned in the tank T, below or at the level of the upper opening O, resting in a dedicated frame TC or upper support (the tank upper frame of rectangular shape forming all or part of this frame TC). Such frame can also serve to support/fasten the lifting system. While the frame TC is here designed as a rectangular frame in non-limiting example of FIG. 2, any suitable configuration for having the powder transfer bag 2′ superimposed relative to the bag 2 can be used. A clamp arrangement pinching a lower end of the powder transfer bag 2′ may be used to allow the pouring (simply by gravity effect) of the powder material.

Referring to FIG. 1, the liquid contained in the parallelepiped bag 2 can be efficiently mixed by the impeller 13 of the stirring device 3, from below, after suitable coupling connection is established between a shaft of the stirring device 3 and the removable drive unit 16. For instance, the unit is inserted in the lower compartment available below the receiving compartment of the tank (insertion using the rear side or any side which is preferably distinct from the front side with the front opening 150 for introduction of the bag 2), such lower compartment or space being apparent in FIG. 2.

The impeller 13 is a plastic part, preferably not containing any metal substance, suitable for contact with biopharmaceutical composition obtained as a mix of a liquid, water for instance, and one or more substances that are initially in a solid, pasty, semi-liquid state or possibly in liquid state (optionally with active substances dissolved in another liquid).

Now referring to FIGS. 1, 3, 5A-5B and 6, exemplary bags 2 are described.

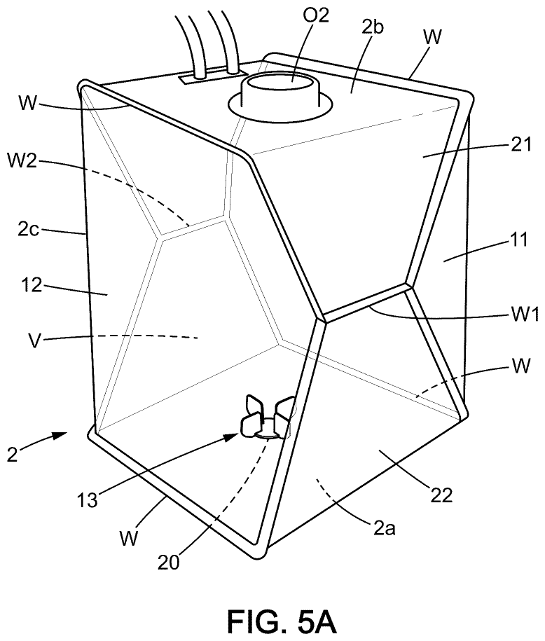

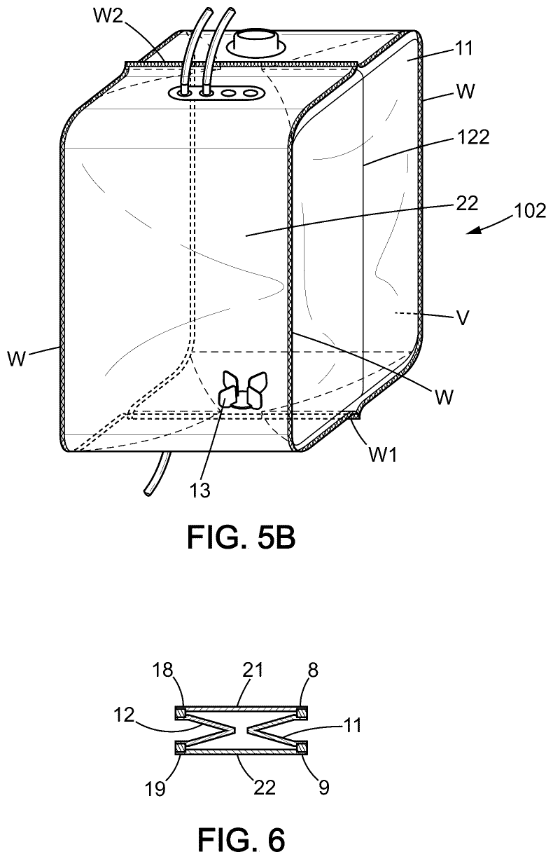

The bag 2 may be produced by assembling four pieces, namely four films or sheets of plastic material. Two sheets are initially outer sheets 21, 22 and the two other sheets are gussets 11, 12, as apparent in FIGS. 5A-5B. The two outer sheets 21, 22 are used to form:
a first wall element, which is typically a flexible part (outer sheet 21) consisting of a multilayer film and making it possible to define a face of the flexible bag 2 (a front face in the initially folded bag 2 as shown in FIG. 3),
a second wall element produced similarly or identically (by a multilayer film), which is a flexible part (outer sheet 22) making it possible to define a rear face of the flexible bag 2 such as shown in FIG. 3.

The gussets 11 and 12 can have a similar material and a similar thickness (preferably identical) to what is provided for the two outer sheets 21, 22. It is understood the gussets 11 and 12 are constituted by respective films, for instance cut from one part. The cut could occur before, during or after the step of connection with the sheets 21, 22. Advantageously for a filling with a biopharmaceutical fluid, the inner layer of each of the films which compose the flexible bag 2 is made of hot-weldable plastic material, which is biocompatible with the mediums transported. In a preferred embodiment, each film has a multilayer structure with layers which are typically non-metal, plastic layers. As a non-limiting example, the film can be transparent or translucid. The sheets may be of same plastic material.

According to some embodiments, the end seals W1, W2 and the longitudinal seams W are forming junctions by a local heating for a sufficiently long exposure period to heat, using a weld head. Heating technique by a low-voltage electrical impulse can be used such that the appearance of the visible face is unchanged, while guaranteeing a good weld quality: indeed, it does not require any high pressure at the time of the weld.

Impulse weld, thermal or laser weld techniques can make it possible to obtain resistant welding seals and seams W1, W2, W. In the case of a thermal weld, it is preferable to simultaneously weld the four films by applying a pressure of between 4 and 8 bars between weld blades or bars, using the configuration shown in FIG. 6, possibly before a trimming operation to remove margin parts. The thickness is typically broadly greater than 100 micrometers for each plastic sheet, so that it is preferably to provide an exposure duration of at least 2 or 3 seconds, the exposure duration being for instance between 3 and 6 seconds.

Referring to FIGS. 5A, 5B, the bag 2 may have a longitudinal extension and four longitudinal seams W. Thanks to the welding, the seams include two longitudinal sheet margins (margins from two adjacent plastic sheets) that have been melt to become one strip-like junction. At the end seals W1, W2, four longitudinal sheet margins may overlap.

Referring to FIG. 3, the bag 2 as initially folded has a height H. The useful height h in unfolded state is lower than height H, due to retractation of the gussets. Height h is measured between the bottom wall 2a and the top wall 2b in the unfolded configuration. The two end seals W1, W2 are distant here from an initial distance (in folded state), which is equal to height H. The two end seals W1, W2, which extend parallel, may be each connected at a first junction with two of the four longitudinal seams W and at a second junction with two others of the four longitudinal seams W.

While FIG. 5A shows, in a perspective view, a 3-D flexible bag 2 having a K-shaped weld at least one of the ends, other junctions can be used. For instance, FIG. 5B a bag 2 with longitudinal seams W that are parallel along the whole length of the bag 2 in the unfolded configuration, the longitudinal seams W being as long as the bag in this configuration.

In a preferred embodiment, the gussets each have an inner, hot-weldable layer, made of a material selected from among polyethylene (preferably linear low density) and ethylene vinyl acetate copolymer; and an outer weldable layer, made of a material selected among polyethylene (preferably linear low density, or possibly linear high density), polyamide, ethylene vinyl acetate copolymer, polyamide and polyethylene terephthalate.

An intermediate layer, for example having a barrier effect (for example EVOH-based or equivalent material), can be provided in the multilayer structure of the elements 11, 12, 21, 22 delimiting the interior volume of the flexible bag 2.

Now referring to FIG. 3, it can be noted, that the gussets 11 and 12 are spaced apart from one another by a transverse space. Such transverse space delimited between the initial fold lines 112 of the gussets 11, 12, may correspond to a constant distance in the flat configuration, as can be seen in FIG. 3. The gussets 11, 12 may be deprived from any port, while at least one of the outer sheets 21, 22 may comprise one or several openings 20, O2 to form ports. When the bag 2 is filled with liquid, with a top of the bag 2 already maintained at high level in the tank T, the bag walls stretch so that the gussets 11,12 are moving away from each other, with an interspace superior to the initial transverse space between the fold lines 112. The interspace may be superior or equal to 150 mm, which is of interest for disposing a port and/or connecting parts, for instance for allowing centering of a stirring device before unfolding, so that is can be arranged at mid distance between the gussets 11, 12 in parallelepiped configuration).

In some options, the bag 2 is provided with one or more non-containing parts NCP (not delimiting the interior volume V), which may serve for fixation with the linking element 6 of the lift system LS and/or for handling the bag 2. Possibly, four parts NCP are connected to a cross bracket or similar lifter beam. In some options a handle may be formed at a top of the bag 2. At the bottom wall 2a, the opening 20 may be associated with/covered with a rigid cup or with any suitable fitting that is part of a connecting interface allowing a central region of the bottom wall 2a to be centered relative to the base 5. Optionally, such connecting interface retains the bottom wall 2a, which is of interest when displacing the top of the bag 2 upwardly, so that centering of the bottom wall 2a is ensured.

In some options, as illustrated in FIG. 2, the apparatus 1 includes a bracket and a linking element 6 coupled to the bracket. The tank T may be provided with such bracket for holding a top end of the bag 2, the bracket extending above the top opening O of the tank T or at least holding this top end in a high position that does not interfere with the end of a liquid filling operation (filling of the bag) or with agitation that possibly starts before the end of the filling.

More generally, the apparatus may have a lift system LS for controlling unfolding of the bag 2. Once the bracket is fastened and the linking element or cross bracket centered relative to the upper opening O, the sidewall 2C of the bag 2 may be unfolded progressively, by a lifting displacement of a top end of the bag 2. The bottom wall 2a may be retained by a fastening element of the connecting interface (for the coupling with a drive unit 16) and/or by weight of a part of the liquid already present at the bottom of the bag 2.

In some embodiments, the bag 2 is provided with a stiffening part at the top end with a through hole arranged in and/or surrounded by the stiffening part. The linking element 6 can pass through the through hole in a hold configuration of the bag 2, with the top of the bag 2 maintained in a top region of the receiving compartment, using the bracket and the linking element 6.

Near the bottom side, the bag 2 comprises a first opening 20, for instance provided in the plastic outer sheet 21 in FIG. 3. The first opening 20 thus can extend in the bottom wall 2a when the bag 3 is unfolded, allowing driving an impeller 13 from below as illustrated in FIGS. 5A-5B. The first opening 20 may be covered by a lower receiving cup adapted to partly house the stirring device 3. The receiving cup may have an annular connection flange and may protrude downwardly relative to the base 5. The stirring device 3 may extend below the base 5, at the opposite from a second opening O2 provided in the top wall 2b. The stirring device 3 may have a guiding end extending along a vertical virtual axis and through the first opening 20.

When the stirring device 3 is magnetically driven, the first opening 20 is not apparent from outside the bag 2, due to coverage by the receiving cup. This cup is typically fastened (in tight manner), at an annular junction, to the sheet 21 and entirely covering the first opening 20.

The bag 2, housing the stirring device 13 at the cup, can be associated with the drive unit 16 for levitating and/or rotating the stirring device 13. The drive unit may have a receiving coupler of cylindrical shape, adapted to house the protruding cup.

Referring to FIGS. 2-3, this opening O2 belong to a port suitable for connection with the powder transfer bag 2′ or any other suitable transfer device for addition of a substance to liquid already present in the bag 2. A third opening (not shown) may correspond to a filling and/or draining port arranged in the bottom wall 2a, a flexible hose being connected to such port. At least one flexible hose may also be connected to the top wall 2b (see FIG. 5A)

The opening O2 is here suitable for introduction of such powder material. In some variants, another kind of additional substance may be supplied via a hose, using a suitable opening of the bag 2.

Referring to FIGS. 1-2 and 4A to 5B, bag-to-tank footprint will be detailed. While the gussets 11, 12 and the outer sheets 21, 22 may have same height, the gussets 11, 12 may have a given length L10 (part of a circumference of the bag 2 as measured in a cross-section), in stretched/unfolded state of the bag 2, which is:
lower than length L20 of the outer sheets 21, 22,
and lower than width L1 of the tank T.

In other words, the length L10 is typically a width of the bag 2 since the gussets 11, 12 have fold lines 112 that remain mutually distant in folded configuration. Accordingly, the outer sheets 21, 22 define a greater face. In some embodiments of interest, the following relationship is satisfied:

$$L 2 > L 20 > L 1 > L 10$$

In FIG. 1, when seams W of the bag 2 have vertical extension in unfolded configuration, they are protruding radially outward, facing corner regions 7 that are elongated vertically. An elongated gap is formed locally between the bag 2 and the inner face of the tank T, such gap corresponding for instance one of the four corner regions extending along a same vertical edge 17 of the tank T. As reflected in FIG. 4B, only areas of the tank T away from the edges 17 will be in contact with outer face of the bag 2. For each tank panel 15a, 15b, 15c, 15d, only a subpart of the corresponding inner face is in contact with the bag 2. Four substantially rectangular contact areas RA can be provided in the panels which extend each upwardly from the base 5. In the example of FIG. 4B, only a top part of this contact area RA is shown.

Referring to FIG. 1, the bag 2 is stretched due to the weight of the liquid and thus a parallelepiped shape is obtained with the outer faces of the bag 2 extending parallel to a corresponding tank panel 15a, 15b, 15c or 15d. Under the flowable content pressure (water pressure for instance), the bag 2 is stretched to meet the walls/panels 15a, 15b, 15c or 15d of the outer tank T, while the corners provided with the seams W stretch much less, creating a significant curvature. FIG. 1 illustrates curved faces CF obtained in four bag corner portions that extend longitudinally (vertically), each of the curved faces CF separating two adjacent rectangular contact regions forming the contact areas RA.

The seams are formed with a relatively great overlapping width at the welded regions, which may be about 12 mm, for instance superior or equal to 7 mm and inferior to 15 mm.

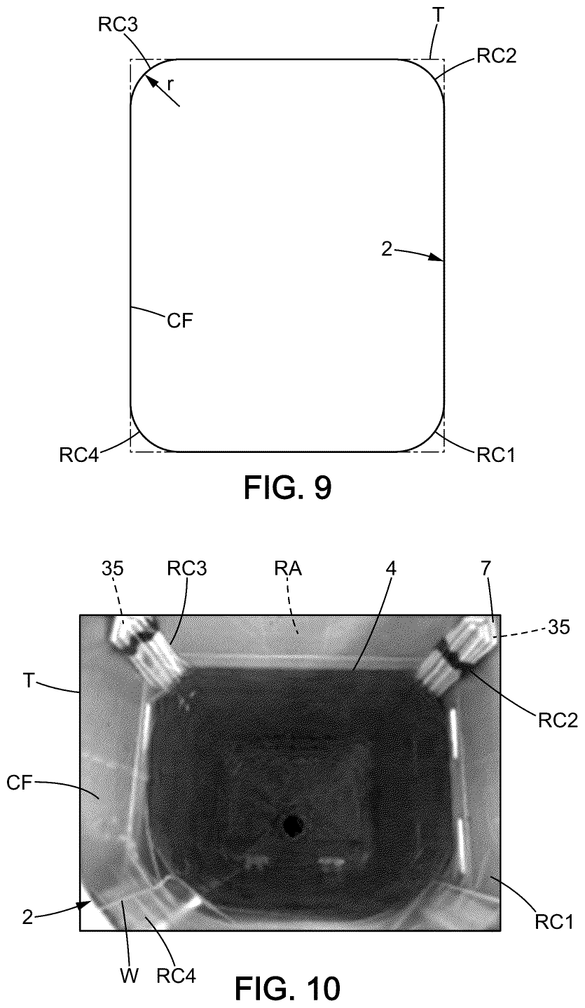

The bag 2 is sized to stretch within limits of a rectangular section that is smaller than rectangular section delimited by the inner face of the tank side wall 15. Referring to FIGS. 4A and 9, it is understood that the bag 2 can have rectangular contact regions that are shorter than the corresponding panels of the tank T due to a reduction in length and reduction in width, typically at least a reduction of about 90 or 100 mm, possibly reaching 140 or 150 mm. The following relationship may be satisfied:

$$0.1 < 4 r / p < 0.45$$

where p is an inner perimeter at the base 5 to delimit the interior volume V (delimitation of a lower part thereof) and r is a curvature radius (see FIG. 9) as measured at any one of the four rounded corners).

The bag 2 is here provided with a rectangular cross section including four rounded corners that are each spaced from the side wall 15 of the tank T, due to the short sizes L10 and L20. The following table shows experiments performed to analyse impact of the bag footprint on a good mixing with powder material that cannot easily dissolve into the liquid if a significant vortex is not present at the top surface of the liquid.

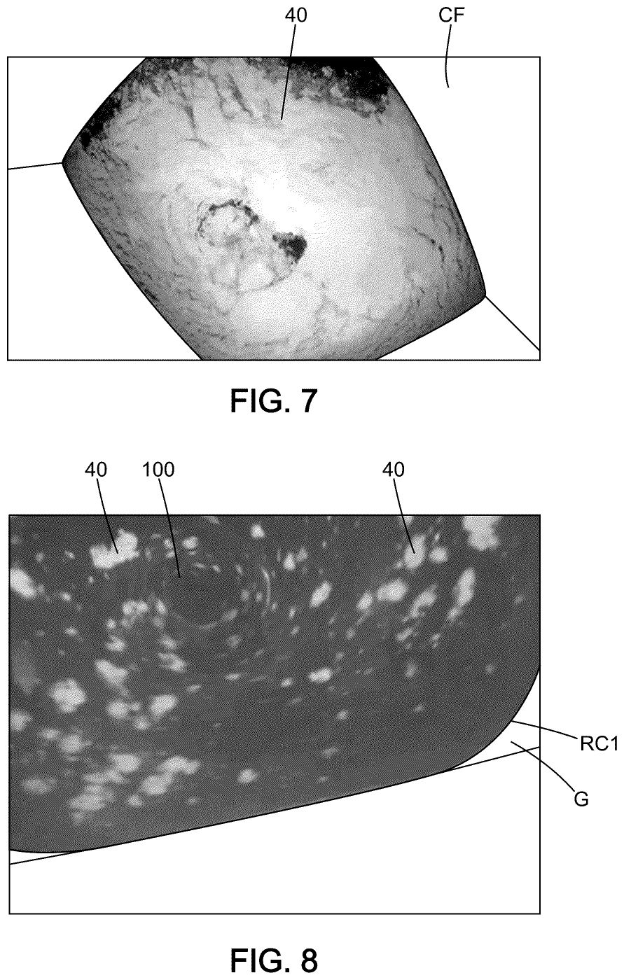

Referring to FIG. 7, it is represented photographically how the powder 40 accumulates above the liquid without any satisfying mixing, due to absence of a vortex 100 (see FIG. 1 for a vortex 100 that facilitates mixing, with reduction of time spent to obtain a homogeneous composition in the interior volume V). The bag 2 illustrated in FIG. 7 is correctly unfolded and fills the corner regions of the tank T: this is of interest to reduce as much as possible total height of the bag 2.

However, the lack of mixing for high bag capacities is an issue. The table below reflects gain in mixing operations due to special rounding at the four vertically elongated corner regions of the bag 2, using sizes L10 and L20 that are surprisingly highly efficient to obtain a vortex 100 despite a height superior or equal to 3000 mm (i.e. with a challenge to propagate the impeller rotation action to the top surface of the liquid).

The experiments as reflected below were performed at same rotational speed of 500 rpm, using same tank T and sale kind of impeller 13, here a Rushton impeller. Filling level was 2400 L with water forming the liquid before pouring a same amount (30 liters) of powder 40. At this point, addition of powder is started to mix and fill up to a total volume of 3000 L once all powder 40 is added.

TABLE

| | | | | | Range of | |
|---|---|---|---|---|---|---|
| | | | | | Curvature | |
| | | | RIGID | | Radius | |
| | BAG | | TANK | Average time to | at each of the | Success |
| | cross | BAG | Cross | vortex | four side wall | rate to |
| TEST | section | height | section | (minutes:seconds) | junctions | vortex |
| A | 1114 × | 3000 | 1135 × | N/A | [2 cm-7.7 cm] | 0% |
| | 914 mm | | 935 mm | | | |
| B1 | 1040 × | 3000 | 1135 × | 2:00 | [19 cm-25 cm] | 75% |
| | 840 mm | | 935 mm | | | |
| B2 | 1040 × | 3090 | 1135 × | 2:00 | [19 cm-25 cm] | 75% |
| | 840 mm | | 935 mm | | | |
| C1 | 1000 × | 3100 | 1135 × | 2:09 | [29 cm-34 cm] | 100% |
| | 800 mm | | 935 mm | | | |
| C2 | 988 × | 3100 | 1135 × | 1:20 | [29 cm-34 cm] | 100% |
| | 788 mm | | 935 mm | | | |
| C3 | 1012 × | 3250 | 1135 × | 1:32 | [29 cm-34 cm] | 100% |
| | 812 mm | | 935 mm | | | |

The test A reflects the case illustrated in FIG. 7. Such cross-section was considered suitable in many applications with the total height of the tank being typically inferior or equal to 1000 or 1200 mm. The bag 2 according to test A satisfactorily unfolds and matches suitably with shape and size of the tank T. But when height is greater, here 3000 mm according to the experiments, there is no possibility to obtain a vortex 100.

In contrast with the tests C1, C2, C3, it can be seen that bag height is still increased despite this size is already about three times greater than the two other sizes (length and width), here becoming superior to 3000 mm without being over 3250 mm, in order to have a sufficient interior volume V despite reduction for width L10 (only 788, 800 or 812 mm) and length L20 (988, 1000 or 1012 mml). Referring to FIG. 8 which reflects test C3, it was advantageously observed that the bag 2 withstands the liquid pressure with rounded corner regions formed, extending vertically parallel to the tank edges 17, so that a significant gap G is present along each edge 17. For any cross-section of the bag 2, near the base 5 or near the liquid top surface as well, each rounded corner RC1, RC2, RC3 or RC4 is stretched with a rounding: a vortex 100 can be seen at or near the centre of the top surface of the to-be-mixed composition. As a result, powder 40 added from above is quickly dissolved.

Referring to FIG. 9, the cross section of the bags 2 used in the tests B1, B2, C1, C2, C3, in unfolded/stretched configuration, is provided with a significant radius of curvature r, at the rounded corners RC1, RC2, RC3, RC4. For a given perimeter p between 4000 mm and 4200 mm, it is understood that mixing can occur more quickly/efficiently when the radius of curvature r is more than 150 mm, or instance between 180 or 190 mm and 340 or 350 mm. For avoiding to much rounding, causing an increase in height, this curvature radius may be less than 350 or 400 mm.

When the curvature radius is of an order of magnitude much smaller than a width of the bag cross section (in unfolded configuration), for instance lower than 90 or 100 mm when the width is about 900 mm, there is no possibility for the powder 40 or any other additional substance be adequately mixed:there is a lack of downward attraction, reflected by absence of suitable vortex.

Here, height dimension of the bag 2 may vary. For instance, the bag 2 is at least 1600 mm tall in unfolded configuration, the height being for instance about 2100 or 3000 mm for a capacity V2 higher than 1500 L. In some options, bag cross-section is specifically chosen to have a circumference significantly lower than the inner perimeter p of the tank cross-section, while properly allowing contact, typically flat contact, onto the respective four panel inner faces of the tank T.

It is to be noted that the positive effect for the mixing is encountered for both cases illustrated in FIGS. 5A and 5B. Position of the gussets 11, 12 in the tank T or symmetrical position of the impeller relative to the bottom wall 2a do not play a significant role as compared to bag-to-tank footprint. The more central position of the impeller 13 in FIG. 5A may be provided but the results of the above table were verified without necessarily having this position, using a slightly shifted position of the impeller 13 as in FIG. 5B.

Here, width of the bag 2 equals twice the width of a gusset 11 or 12 in the folded state (as shown in FIG. 3), for instance half width of a gusset 11, 12 is 400 mm for case C1. The length of the rectangular section, of 1000 mm in case C1, may reflect distance between the seams W, such distance measured along width of an outer sheet 21 or 22.

Capacity V2 of the bag 2 may be substantially identical to the interior volume V delimited by the bag sidewall 2c. Practically, the bag 2 has no undesirable fold and the footprint of the impeller 13 (or other part/instrument possibly disposed inside the bag 2) has a low impact so that capacity V2 as verified with the bag 2 unfolded inside the tank T is close or almost equal to the bag interior volume V delimited by the sidewall 2c in fully stretched parallelepiped configuration of the bag 2.

Once received in the receiving compartment, the bag 2 resting on the base 5 is unfolded, using the lift system LS and is filled with liquid, possibly water. Before starting a stirring operation, the bag 2 (in the filled state) has a parallelepiped configuration and is maintained upright thanks to the four panels 15a, 15b, 15c, 15d. Practically, the bag 2 is in contact with each of the four panels 15a, 15b, 15c, 15d that are vertical panels. Contact between the bag 2 and each of the four vertical panels 15a, 15b, 15c, 15d may be obtained at four respective substantially rectangular contact areas which extend each upwardly from the base 5. Typically, the rectangular contact area RA along a given panel is obtained with a contact width representing more than 50%, preferably, at least 60%, of the panel width of the given panel.

Once the bag is stretched under liquid pressure but with a containment effect due to the side panels 15a, 15b, 15c, 15d, it becomes parallelepiped with a sidewall 2c in contact against the four side panels 15a, 15b, 15c, 1, with a rectangular cross section including four rounded corners RC1, RC2, RC3, RC4 each spaced from the side wall 15, with the following relationship satisfied:

$$0.1 < 4 r / p < 0.45$$

where p is an inner perimeter at said base, r is a curvature radius d at the four rounded corners.

Accordingly, a significant fraction of the bag circumference is not in contact with the side panels 15a, 15b, 15c, 15d. Typically, more than 15% of the bag circumference (bag outer perimeter in filled state) is spaced from the tank delimitation, each rounded corner being included in a vertically elongated corner portion where liquid pressure is not counterbalanced by reaction of a tank side panel.

After mixing, a connection port connected to a suitable flexible pipe allows emptying the bag. Such flexible pipe may extend downwardly from the bag 2 which is received above the lower space 10. More generally, the flexible bag 2 includes one or more connectors forming connection ports, optionally provided on a same outer sheet 21 or 22, to make it possible to fill the flexible bag 2 (with typically several inlet or supply openings). Here, the flexible pipes connected to the connectors (see FIG. 5A for instance) are of a type known per se; a lower flexible pipe (not shown) can also be provided for the draining. The gussets 11, 12 have predefined folds, in particular folding lines 112, formed during the design of the flexible bag 2 (see FIG. 6), which facilitate a correct unfolding as the filling level, typically with a biopharmaceutical fluid, increases.

Of course, the position of the connection port(s) can vary, preferably by making openings on one (preferably only one) of the outer sheets 21, 22. These connection ports are placed at a distance from the connection zones (seams W, end seals W1, W2) between the two outer sheets 21, 22, and they do not interfere with the unfolding of the gussets 11 and 12 of the flexible bag 2, of 3-D type. The ports can be closed sealed in a manner known per se (the ports are connected sealed to a tube length or pipe itself blocked, sealed, by a clip generally called “clamp” by a person skilled in the art, a aseptic connector, or could include one-way dampers or valves or other similar sealed closing systems).

Examples of functional, multilayer films making it possible to constitute the wall elements, i.e. the gussets 11, 12 and the outer sheets 21, 22 of the flexible bag 2 may be films of great flexibility coupled with a satisfactory resistance, which facilitates the unfolding of the gussets 11, 12 without risk that a swelling (during filling) in any bag end or in the sidewall 2c generates a breaking of the film.

The folding lines 112 for each gusset 11, 12 are thus straight-lined and parallel to the side edges 8, 18 and 9, 19 defined by the wall elements. It can be seen that the folding lines 112 extend on either side of a longitudinal axis (in this case, a central axis, as can be seen in FIG. 3) of the flexible bag 2 in the flat configuration.

Referring to FIGS. 1 and 5A-4B which represent the flexible bag 2 in a biopharmaceutical fluid-filled state, the first gusset 11 is connected to two side edges 8 and 9 of either of the first and second outer sheets 21, 22. Similarly, the second gusset 12 is connected to two other side edges 18 and 19 of either of first and second outer sheets 21, 22. Referring to FIG. 6, the connection to the side edges 8, 18 of the first outer sheet 21 and to the side edges 9, 19 of the second outer sheet 22 results from a direct weld, by thus fixing the margin zones of the gussets 11 and 12, which follow the side edges 8, 9, 18, 19. Below, these margin zones will be called longitudinal edges.

The first gusset 11 and the second gusset 12 can each be folded along the folding line 112 thereof, towards the inside. In this example, the folding is done in two equal halves for each gusset 11, 12, at least in the flat configuration of the flexible bag 2. Each folding line 112 extends between two opposite ends of the flexible bag 1 where the gussets 11, 12 are joined with the outer sheet axial ends.

Embodiments with a bag 2 having specific rounded corners RC1, RC2, RC3, RC4 forming a significant radius of curvature r are of interest to facilitate mixing. Effective mixing, which is a challenge at high volume, is repeatably obtained. The relatively high radius r, combined with efficient containment in a tank T of rectangular shape, cumulatively facilitates:
the mixing, especially powder-liquid mixing (which requires good dispersion and dissolution of particles), with a vortex 100 that is apparent at the top of the bag content; and
appropriate unfolding of the bag at the filling operation, with collapse of the bag once drained/emptied, in order to prevent losses in product and/or waste of time in draining the product.

While the stirring device 3 has been shown with a symmetrical impeller 13, for instance Rushton impeller, typically with a shaft 30 extending downwardly, any suitable stirring part may be used. Besides, magnetic coupling may be provided to allow rotation of such stirring part. A short shaft 30 for guiding rotation may be provided.

Also, the stirring device 3 may comprise any suitable configuration for agitation, with one or more impellers 13 driven for initiating agitation adjacent to a tank base 5. Embodiments are not limited, neither with respect to the specific design of the one or more impellers, or regarding rotational speed involved. Many options with enough agitation, in order to allow liquid movement to propagate upwardly (from the bag region adjacent to the base 5), are available. Rotation speed of 500 rpm has been only indicated as a non-limiting example. In other options, rotational speed may be lower, for instance about 400 rpm or less. Such lower speed may be used with a bag height h lower than 2500 or 3000 mm. Higher rotations speed can also provide efficient results, for instance a speed of 700 or 900 rpm may be involved.

1. An apparatus having a single-use bag filled with a liquid of a biopharmaceutical composition, the apparatus being capable of mixing the biopharmaceutical composition and comprising:
the bag, made of flexible plastic material, provided with a bottom wall, a top wall and a tubular sidewall extending from the bottom wall to the top wall so that the bag delimits an interior volume;
a tank provided with a base that is rectangular, the tank comprising a side wall that is rigid and provided with four panels extending upwardly from the base, in order to delimit a receiving compartment;
a stirring device located in the interior volume and adapted to be driven from below, at the opposite from the top wall;
wherein the bag is placed inside the tank and arranged above the base and between the four panels, in the receiving compartment,
wherein the bag, in an unfolded configuration of the bag due to the liquid present inside the bag, has a parallelepiped configuration and is:
extending vertically, parallel to a central axis of the tank that intersects an upper opening of the tank,
provided with a rectangular cross section including four rounded corners that are each spaced from the side wall of the tank, the rectangular cross-section being in correspondence with rectangular distribution of the four panels, and
satisfying the two following relationships:
$$0.1 < 4 r / p < 0.45 \\ V 2 \geq 1500 L$$
where p is an inner perimeter at said base to delimit the receiving compartment, r is a curvature radius as measured at any one of the four rounded corners, and V2 is the capacity of the bag.

2. The apparatus according to claim 1, wherein the bag is in contact with each of the four panels, the four panels being vertical panels, and wherein contact between the bag and each of the four vertical panels is obtained at four respective rectangular contact areas which extend each upwardly from the base.

3. The apparatus according to claim 1, wherein the bag has a height measured between the bottom wall and the top wall in the unfolded configuration, the height being superior to 900 mm.

4. The apparatus according to claim 1, wherein the bag has a longitudinal extension and comprises four plastic sheets and four longitudinal seams so that two of the four plastic sheets are gussets, each of the four longitudinal seams including two longitudinal sheet margins distributed in two adjacent plastic sheets that are part of the bag.

5. The apparatus according to claim 4, wherein the two gussets are identical sheets, preferably made of a multilayer plastic film.

6. The apparatus according to claim 4, wherein the bag has a height measured between the bottom wall and the top wall in the unfolded configuration, the bag comprising two end seals that are distant from an initial distance, in folded state of the bag, which is higher than the height, wherein the two end seals, which extend parallel, are each connected at a first junction with two of the four longitudinal seams and at a second junction with two others of the four longitudinal seams.

7. The apparatus according to claim 4, wherein the inner perimeter at said base is identical to an inner circumference delimited by the four panels, the bag in the unfolded configuration being kept upright without any contact between the four longitudinal seams and the four panels,
and wherein the tubular sidewall has a given height in said parallelepiped configuration, with each of the seams having an elongated seam portion that is:
extending vertically, and
protruding outwardly from the tubular sidewall (2c) of the bag (2).

8. The apparatus according to claim 6, wherein the two end seals are distributed in the bottom wall and the top wall, the stirring device comprising an impeller that is shifted laterally relative to the end seal (W1) provided in the bottom wall.

9. The apparatus according to claim 6, wherein the two end seals are provided in the tubular side wall, the stirring device comprising an impeller that is preferably arranged centrally with respect to the bottom wall.

10. The apparatus according to claim 1, wherein the stirring device is configured to rotate around a vertical virtual axis, and wherein the bag comprises an opening in the top wall, suitable for introduction of powder in the interior volume from above.

11. The apparatus according to claim 10, wherein the stirring device comprises only a single impeller, which is preferably a Rushton impeller, driven magnetically, a spacing height between the impeller and the top wall being comprised between 2000 and 3400 mm.

12. The apparatus according to claim 1, wherein contact between the bag and each of the four vertical panels is obtained at four respective rectangular contact areas which extend each upwardly from the base.

13. The apparatus according to claim 1, comprising a bracket and a linking element coupled to the bracket for:
unfolding the bag by a lifting displacement of a top end of the bag, the bracket belonging to a lift system;
and holding the top end of the bag.

14. The apparatus according to claim 13, wherein the bag is provided with a stiffening part at the top end, preferably with a through hole arranged in and/or surrounded by the stiffening part, the linking element being configured to be engaged with the bag at or through the stiffening part, preferably by passing through the through hole, in a hold configuration of the bag using the bracket and the linking element.

15. The apparatus according to claim 1, comprising a fastening element configured to selectively retain a central region of the bottom wall 2a, in a predetermined position relative to the base of the tank T, wherein the sidewall is unfolded in response to a lift action exerted at a top end of the bag, by a lift system extending above and/or resting on a annular frame of the tank which surrounds an upper opening of the tank, the annular frame protruding radially outwards relative to a tank outer face of rectangular section.

16. The apparatus according to claim 1, wherein the tank is provided with vertically elongated spacers covering vertical tank edges, so that in said unfolded configuration of the bag, the bag is in contact with the panels of the tank and with the spacers in alternance along circumference of the bag.

17. A method for mixing in single-use bioreactors, using a bag specifically designed to contain a biopharmaceutical composition including a liquid, wherein the bag, made of flexible plastic material, is a 3D-bag adapted to have a parallelepiped configuration so that the bag is provided with a bottom wall, a top wall and a tubular sidewall extending from the bottom wall to the top wall, the method comprising:
opening a front opening opening to a receiving compartment of a tank, the tank comprising a side wall that is rigid and provided with four panels extending upwardly from a base that is rectangular, in order to delimit the receiving compartment;
placing the bag in the receiving compartment, above the base;
while the front opening is open, connecting a stirring device, which extends inside the bag, to a drive unit arranged below the receiving compartment, the stirring device being configured to be driven from below, at the opposite from the top wall, to mix liquid content of the bag;
lifting a top end of the bag to start unfolding two opposite gussets of the bag;
simultaneously filling the bag with liquid and further unfolding the bag to reach parallelepiped configuration of the bag,
wherein the bag, once placed inside the tank and unfolded according to the unfolded configuration, is:
extending vertically, parallel to a central axis of the tank that intersects an upper opening of the tank,
provided with a rectangular cross section including four rounded corners that are each spaced from the side wall of the tank, the rectangular cross-section being in correspondence with rectangular distribution of the four panels, and
satisfying the two following relationships:
$$0.1 < 4 r / p < 0.45 \\ V 2 \geq 1500 L$$
where p is an inner perimeter at said base to delimit the receiving compartment, r is a curvature radius as measured at any one of the four rounded corners, and V2 is the capacity of the bag.
